(19) United States
(12) Patent Application Publication
(10) Pub. No.: US 2015/0143510 A1
(43) Pub. Date: May 21, 2015

(54) SYSTEMS AND METHODS FOR NOTIFYING A USER OF A USER ENTRY THAT MATCHES SECURITY INFORMATION AND FOR HIDING DISPLAY OF A USER ENTRY THAT MATCHES SECURITY INFORMATION

(71) Applicant: Toshiba Global Commerce Solutions Holdings Corporation, Tokyo (JP)

(72) Inventors: Douglas Hanthorn, Raleigh, NC (US); Jason Chirakan, Raleigh, NC (US); Seth T. Teeples, Cary, NC (US); Brad M. Johnson, Raleigh, NC (US)

(73) Assignee: Toshiba Global Commerce Solutions Holdings Corporation, Tokyo (JP)

(21) Appl. No.: 14/193,031

(22) Filed: Feb. 28, 2014

Related U.S. Application Data
(60) Provisional application No. 61/907,134, filed on Nov. 21, 2013.

(51) Int. Cl. G06F 21/31

(52) U.S. Cl. CPC G06F 21/31
USPC 726/19

(57) ABSTRACT

Systems and methods for notifying a user of a user entry that matches security information and for hiding display of a user entry that matches security information are disclosed. According to an aspect, a method includes receiving user text input. The method also includes determining whether the user text input matches a predetermined portion of security information. Further, the method includes presenting notification of the match via a user interface in response to determining that the user text input matches the predetermined portion of the security information.

### CROSS REFERENCE TO RELATED APPLICATION

This application claims the benefit of U.S. Provisional Patent Application No. 61/907,134, filed Nov. 21, 2013 and titled SYSTEMS AND METHODS FOR NOTIFYING A USER OF A USER ENTRY THAT MATCHES SECURITY INFORMATION AND FOR HIDING DISPLAY OF A USER ENTRY THAT MATCHES SECURITY INFORMATION, the content of which is hereby incorporated herein by reference in its entirety.

### TECHNICAL FIELD

The present invention relates to computing device security and input error prevention. More specifically, the present invention relates to computing devices and methods for notifying users of user entries that match security information, and for hiding the display of user entries that match security information.

### BACKGROUND

Computing device and system users typical utilize passwords and other security information for securing access to applications and data. Other than passwords, example security information includes mother's maiden name, birthdate, favorite food, and the like. Such security information may be entered into a display field and used for verifying and authenticating the user before the grant of initial or continuing access. Often, for example, this authentication or verification is accomplished by requiring the user to enter a username and a password, each composed of a string of characters, known to both the user and the computing device or system.

In many instances, a password is not displayed when it is being typed to prevent others who are nearby from viewing the password, thus keeping the password secret. Rather than displaying the password, a masking element, such as a dot, asterisk, or other character, may be displayed in the password field as the password is being entered. However, if the user accidentally enters their password in a username field, the password can be revealed to others who are nearby. For at least this reason, it is desired to provide improved systems and techniques for securing password and other security information entered by a user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for notifying a user of a user entry that matches security information. According to an aspect, a method includes receiving user text input. The method also includes determining whether the user text input matches a predetermined portion of security information. Further, the method includes presenting notification of the match via a user interface in response to determining that the user text input matches the predetermined portion of the security information.

Further, disclosed herein are systems and methods for hiding display of a user entry that matches security information. According to an aspect, a method includes receiving user text input for entry at a portion of a display screen. The method also includes determining whether the user text input matches a predetermined portion of security information. Further, the method includes hiding display of at least a portion of the user text input on the display screen in response to determining that the text input matches the predetermined portion of security information.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system for notifying a user of a user entry that matches security information and for hiding display of a user entry that matches security information in accordance with embodiments of the present invention;

FIG. 2 is a flowchart of an example method for notifying a user of a user entry that matches security information in accordance with embodiments of the present invention;

FIG. 3 is a flowchart of an example method for hiding display of a user entry that matches security information in accordance with embodiments of the present invention; and

FIGS. 4A and 4B show a diagram depicting an example password protection process in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device capable of receiving a product identifier and geographic location identifier. For example, the computing device may be smart phone configured to read, scan, or otherwise determine a product identifier (e.g., a UPC on a product) of a product. For example, a computing device may be a mobile device such as, for example, but not limited to, a smart phone, a cell phone, a pager, a personal digital assistant (PDA, e.g., with GPRS NIC), a mobile computer with a smart phone client, or the like. A computing device can also include any type of conventional computer, for example, a desktop computer or a laptop computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable electronic device, such as a computer.

As referred to herein, the term “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

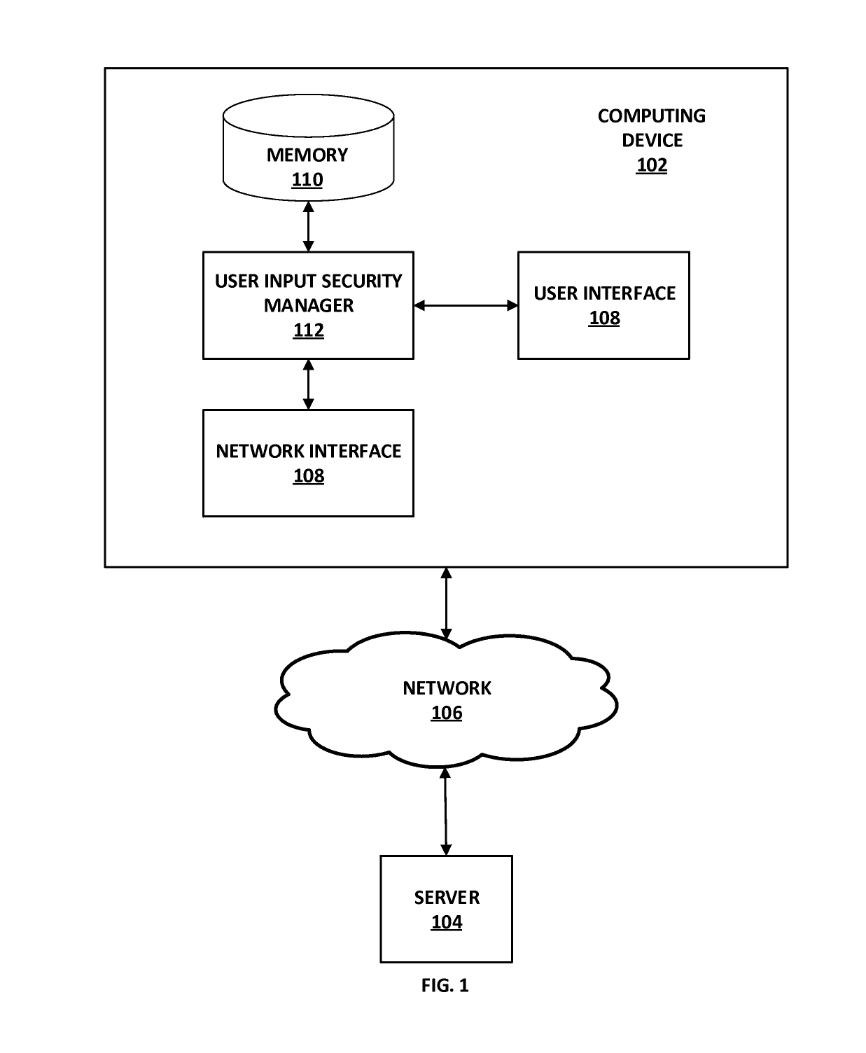

The presently disclosed subject matter is now described in more detail. For example, FIG. 1 illustrates a block diagram of a system for notifying a user of a user entry that matches security information and for hiding display of a user entry that matches security information in accordance with embodiments of the present invention. Referring to FIG. 1, the system includes a computing device 102 and a server 104. As an example, the computing device 102 and the server 104 may be communicatively connected via a network 106, such as the Internet and/or a local area network (LAN). The computing device 102 may include a network interface 108 configured to communicate with the network 106.

In accordance with embodiments of the present invention, the computing device 102 may include a user input security manager 112 configured to receive user text input, to determine whether the user text input matches a predetermined portion of security information, and to present notification of the match via a user interface 108 in response to determining that the user text input matches the predetermined portion of the security information. Further, the user input security manager 112 may be configured to receive user text input, to determine whether the user text input matches a predetermined portion of security information, and to hide display of at least a portion of the user text input on the display screen in response to determining that the user text input matches the predetermined portion of the security information. The user input security manager 104 may be implemented by suitable hardware, software, firmware, or combinations thereof. For example, the user input security manager 104 may be implemented by one or more processors (not shown) and memory 110.

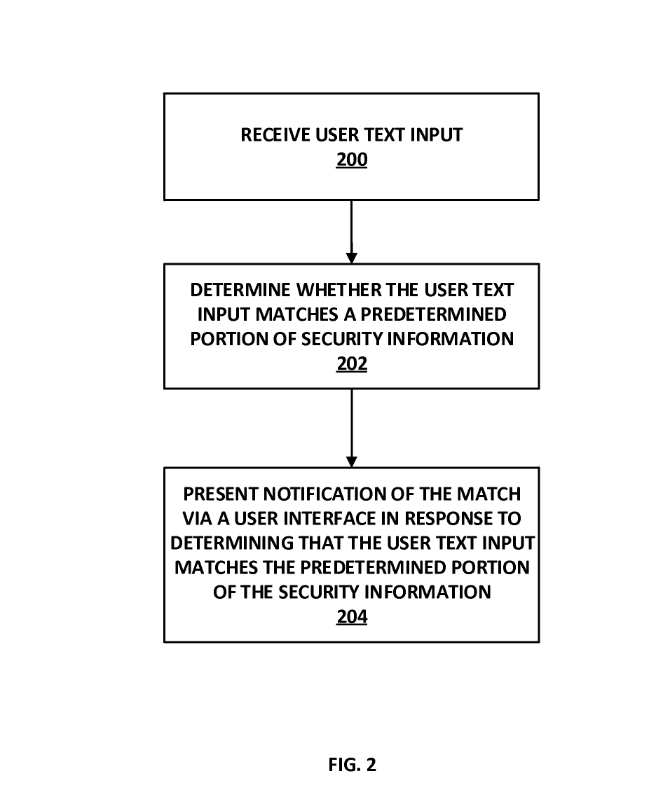

FIG. 2 illustrates a flowchart of an example method for notifying a user of a user entry that matches security information in accordance with embodiments of the present invention. The method is described in this example as being implemented by the computing device 102, although it should be understood that the method may be implemented by any suitable computing device having a user interface, such as a display.

Referring to FIG. 2, the method includes receiving 200 user text input. For example, the user interface 108 may include a display that is controlled to display a username field and a password field for authentication or verification for access to an application and/or data. For example, the username and password fields may be used for entry of a username and password for access to an application and/or data residing on the computing device or another computing device, such as the server 104. In an example, the server 104 may be a web server to present to the computing device 102 a webpage including the username and password fields. The user may interact with a mouse and/or a keyboard to move a cursor for selecting one of the fields for entry of text input. Subsequently, the user may interact with the keyboard or another suitable user interface component for entering a string of characters into the selected field. The user input security manager 112 may receive the string of characters from the user interface 108 as they are entered or soon after they are entered into the selected field.

The method of FIG. 2 includes determining 202 whether the user text input matches a predetermined portion of security information. Continuing the aforementioned example, the user input security manager 112 may maintain and store in the memory 110 one or more usernames and corresponding passwords. These usernames and passwords may be encrypted and may be used for accessing respective applications and/or data. In the example of step 200, the user may intend to input one of the usernames and corresponding password. The user may mistakenly enter a password in the username field. In this case, the manager 112 may recognize that text is being entered in a field in which the data can be exposed (i.e., a username field). In response to this recognition, the manager 112 may compare the entered string of text characters to corresponding portions of text in the stored list of passwords. Based on the comparison, the manager 112 may determine whether the entered text matches the corresponding portion of security information. The comparison may not be made until a predetermined number of characters have been entered. For example, the comparison may not begin until at least 5 characters in the string have been entered. In another example, masking may not begin until at least half the characters match a password.

The method of FIG. 2 includes presenting 204 notification of the match via a user interface in response to determining that the user text input matches the predetermined portion of the security information. Continuing the aforementioned example, the manager 112 may determine that the first 5 or more characters entered in the username field matches the corresponding first 5 or more characters of a password stored in the memory 110. In response to this determination, the manager 112 may control the user interface 108 to present notification of the match. For example, the manager 112 may control a display to display a message or another indicator indicating the match. As an example, the display may display the message, “You are possibly entering a known password. Are you sure you want to continue?”. If the user replies “Yes” to the query, the password matching may be stopped so that an unauthorized person cannot guess the password by continuing to enter characters. If the user replies “No” to the query the operation is canceled, thus implying that the field is blanked out and the cursor resets to the beginning of the current field. Therefore, the unauthorized person cannot continue guessing since no additional clues (i.e., blocking or masking of characters) are provided.

In another example of notifying, the manager 112 may, alternatively or in addition to presenting the message, hide or mask by a dot, asterisk, or other character the characters entered in the username field. In another example, the manager 112 may lock or otherwise prevent entry of additional text in the username field. In this way, a user may be notified and/or prevented from entering an entire password in the username field or another field in which the entered text may be viewed by others.

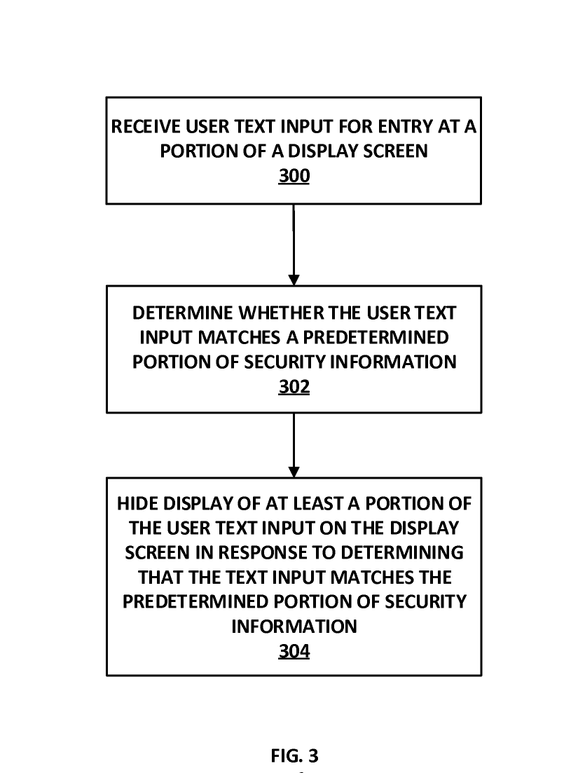

FIG. 3 illustrates a flowchart of an example method for hiding display of a user entry that matches security information in accordance with embodiments of the present invention. The method is described in this example as being implemented by the computing device 102, although it should be understood that the method may be implemented by any suitable computing device having a user interface, such as a display.

Referring to FIG. 3, the method includes receiving 300 user text input for entry at a portion of a display screen. For example, a user may begin typing a string of characters for entering a password in a username field. The manager 112 may receive the entered characters as they are typed in.

The method of FIG. 3 includes determining 302 whether the user text input matches a predetermined portion of security information. Continuing the aforementioned example, the manager 112 may determine whether the first of a predefined number of characters matches corresponding characters of a stored password. For example, the manager 112 may determine whether the first 3 characters entered matches the first 3 characters of any of the stored passwords.

The method of FIG. 3 includes hiding 304 display of at least a portion of the user text input on the display screen in response to determining that the text input matches the predetermined portion of security information. Continuing the aforementioned example, the manager 112 may control the display to hide or mask by a dot, asterisk, or other character the characters entered in the username field. Stated another way, these characters are hidden or masked as they are entered, thus a viewer of the display cannot see the characters that are entered. The manager 112 may continue to hide the entered characters in this way so long as the characters continue to match corresponding characters of one of the passwords. In this way, the entry can be hidden from view so long as the entered characters continue to match a known password. In response to determining that the characters do not match, the manager 112 can unhide all of the entered characters, because it is likely the user is not mistakenly entering a password in the username field or any other field.

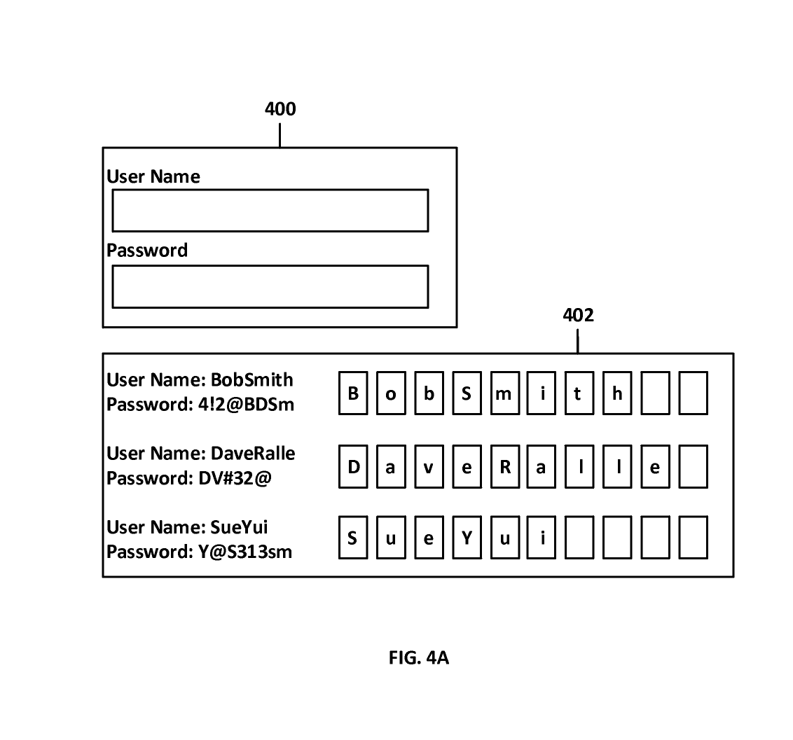

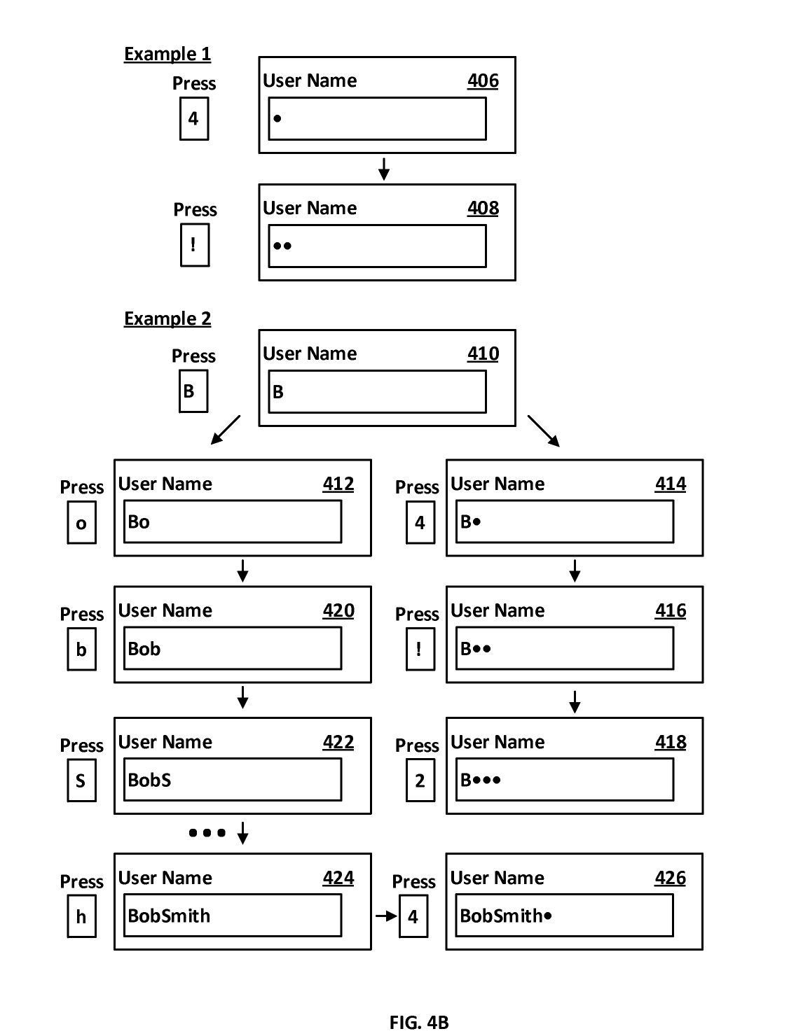

FIGS. 4A and 4B illustrate a diagram depicting an example password protection process in accordance with embodiments of the present invention. Referring to FIG. 4, a portion of a display 400 shows presentation of a username field and a password field for entry of a username (or user ID) and password, respectively, for accessing applications and/or data. In this example, a username and password may be entered in a web browser of a computing device for accessing one or more webpages or content at a web server, although it should be understood that a username and password may be entered for accessing any type of application or data. The username and password for the user may be stored remotely at a web server, such as the server 104 shown in FIG. 1. The username and password may also be stored at a computing device (e.g., the computing device 102 shown in FIG. 1) in accordance with embodiments of the present invention. It is noted that the user name and password may be one of multiple usernames and passwords stored in the computing device for accessing applications and/or data. The user input security manager 112 may be configured to recognize that username and password fields for a particular webpage is being displayed, and that a particular stored username and password can be used to access data or applications via the displayed webpage. The user input security manager 112 may also recognize that multiple different usernames and passwords can be used for accessing a particular webpage, or other applications and/or data. The user ID can be stored in a browser or website when setting up an account.

In the example of FIG. 4A, a user of the computing device may use a keyboard or other user interface to enter characters in the fields shown in the display portion 400. The entry of characters may occur after the display of the fields. Examples of this subsequent step are depicted in portion 402, which shows three (3) examples of acceptable usernames and respective passwords for entry in the fields of display portion 400. Only the correct characters entered in the correct order can be viewed.

Now referring to FIG. 4B, example entries in the username field of display portion 400 are shown for illustrating a process in accordance with embodiments of the present invention. Particularly, in Example 1, display portions 406 and 408 show an example result of the entry of the sequence of characters “4” followed by “J” within the username field. In both instances, the entered character is masked such that the user or a viewer of the display cannot see the character in the field. The characters are masked because the entry is matching the first 2 characters of the password “4!2@BDSm” for “BobSmith”.

In Example 2 shown in FIG. 4B, different scenarios are provided depending on the sequence of characters entered by the user at different times. Initially, in this example, the user enters the character “B,” and the character is shown in the username field without masking as shown in display portion 410. Subsequently, in one scenario, the user enters the character “o,” and the character is not masked as shown in display portion 412, because it corresponds to a stored username, not a password.

In another scenario, subsequent to entry of character “B,” the user enters the character “4” and the character is masked as shown in display portion 414, because it is the first character of a stored password. Subsequently, the user enters the character “!” followed by the character “2” and the characters are masked as shown in display portions 416 and 418, because these are the next characters in the password.

Continuing the scenario of entry of characters “B” and “o,” the user next enters the character “b” and the character is not masked as shown in display portion 420, because the entered characters are part of a username. If instead of the character “b” the user enters the character “!,” the character may be masked because it is not part of a recognized username.

Continuing the scenario of entry of characters “B,” “o,” and “b,” the user next enters the character “S” and the character is not masked as shown in display portion 422, because the entered characters are part of a username. If instead of the character “b” the user enters the character “!,” the character may be masked because it is not part of a recognized username. The user may continue to enter the remaining characters of the username “BobSmith” to result in the display portion 424. Any other characters entered after completion of the entry of the recognized username “BobSmith” can result in masking of the character as shown in display portion 426 since no other characters in sequence to the username have been registered, thus any additional character is invalid. In the example of display portion 426, the character “4” is entered after entry of characters corresponding to the username “BobSmith,” and this character is masked.

In accordance with embodiments of the present invention, the manager 112 may determine whether all or a portion of characters entered in a field, other than the password field, match a stored password. In response to this determination, the manager 112 may move entry to a password field. In this way, the entered information can be hidden by other characters (e.g., asterisks) in the password field and also already placed there for convenience of entry.

In accordance with embodiments, the present disclosure can be applied to web forms for entry of data via a web browser. For example, a user may enter a username and password on such a web form. The user may accidentally type in a password into the username field. In an example, when creating an access account on a web form, a user identifier may be stored (either online or natively in software). To keep only valid user IDs visible at any time, any character not matching an existing ID can appear as a dot, asterisk, or other character. When typing, only characters which have been entered in the correct sequence (when compared to a registered user ID) may be displayed on screen, all others may appear as a dot, asterisk, or other character. Any characters typed in the ID field after a valid user ID is entered may also appear as a dot, asterisk, or other character. This may prevent an accidental typing of one's password into the user ID field from being visible on screen.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
receiving user text input;
determining whether the user text input matches a predetermined portion of security information; and
in response to determining that the user text input matches the predetermined portion of the security information, presenting notification of the match via a user interface.

2. The method of claim 1, wherein the security information is a password.

3. The method of claim 1, wherein the security information is one of a plurality of passwords.

4. The method of claim 1, wherein receiving user text input comprises receiving user text input in a text field displayed via a display.

5. The method of claim 1, wherein receiving user text input comprises receiving user text input in a username field displayed via a display.

6. The method of claim 5, further comprising determining whether the user text input is being entered in the username field,
wherein the method further comprises determining whether the user text matches the predetermined portion of the security information in response to determining that the user text input is being entered in the username field.

7. The method of claim 1, wherein presenting notification comprises displaying a message via a display for indicating entry of security information.

8. The method of claim 1, further comprising displaying the user text input via a display.

9. The method of claim 8, further comprising hiding the display of the user text input in response to determining that the user text input matches the predetermined portion of the security information.

10. The method of claim 1, wherein receiving user text input comprises receiving the user text input via the user interface.

11. A method comprising:
receiving user text input for entry at a portion of a display screen;
determining whether the user text input matches a predetermined portion of security information; and
in response to determining that the text input matches the predetermined portion of security information, hiding display of at least a portion of the user text input on the display screen.

12. The method of claim 11, wherein receiving user text input comprises using the text input in a text field displayed via a display.

13. The method of claim 11, wherein the security information is a password.

14. The method of claim 11, wherein determining whether the user text input matches the predetermined portion of security information comprises determining whether the user text input matches any one of a plurality of stored passwords.

15. The method of claim 11, wherein the user text input is a first user text input entered in a display field, and
wherein the method further comprises:
receiving a second user text input in the display field subsequent to receipt of the first user text input;
determining whether the combination of the first and second user text input matches another predetermined portion of the security information; and
in response to determining that the combination of the first and second user text input does not match the other predetermined portion of the security information, unhiding the at least a portion of the user text input on the display screen.

16. A computing device comprising:
at least one processor and memory; and
a user input security manager configured to:
receive user text input;
determine whether the user text input matches a predetermined portion of security information; and
control a user interface to present notification of the match in response to determining that the user text input matches the predetermined portion of the security information.

17. The computing device of claim 16, wherein the security information is a password.

18. The computing device of claim 16, wherein the security information is one of a plurality of passwords.

19. The computing device of claim 16, wherein the user input security manager is configured to receive user text input comprises receiving user text input in a text field displayed via a display.

20. The computing device of claim 16, wherein the user input security manager is configured to receive user text input in a username field displayed via a display.

21. The computing device of claim 20, wherein the user input security manager is configured to:
determine whether the user text input is being entered in the username field; and
determine whether the user text matches the predetermined portion of the security information in response to determining that the user text input is being entered in the username field.

22. The computing device of claim 16, wherein the user input control manager is configured to control a display to display a message for indicating entry of security information.

23. The method of claim 16, wherein the user input control manager is configured to control a display to display the user text input.

24. The computing device of claim 23, wherein the user input control manager is configured to control the display to hide the display of the user text input in response to determining that the user text input matches the predetermined portion of the security information.

25. The method of claim 16, wherein the user input control manager is configured to receive the user text input via the user interface.

26. A computing device comprising:
at least one processor and memory; and
a user input security manager configured to:
receive user text input for entry at a portion of a display screen;
determine whether the user text input matches a predetermined portion of security information; and
hide display of at least a portion of the user text input on the display screen in response to determining that the text input matches the predetermined portion of security information.

27. The computing device of claim 26, wherein the user input security manager is configured to use the text input in a text field displayed via a display.

28. The computing device of claim 26, wherein the security information is a password.

29. The computing device of claim 26, wherein the user input security manager is configured to determine whether the user text input matches any one of a plurality of stored passwords.

30. The computing device of claim 26, wherein the user text input is a first user text input entered in a display field, and
wherein the user input control manager is configured to:
receive a second user text input in the display field subsequent to receipt of the first user text input;
determine whether the combination of the first and second user text input matches another predetermined portion of the security information; and
unhide the at least a portion of the user text input on the display screen in response to determining that the combination of the first and second user text input does not match the other predetermined portion of the security information.
